(19) United States
(12) Patent Application Publication
(10) Pub. No.: US 2021/0003764 A1
(43) Pub. Date: Jan. 7, 2021

(54) DISPLAY DEVICE AND DISPLAY CONTROL METHOD

(71) Applicant: Coretronic Corporation, Hsin-Chu (TW)

(72) Inventors: Chih-Jen Tsang, Hsin-Chu (TW); Ming-Huei Shiu, Hsin-Chu (TW)

(73) Assignee: Coretronic Corporation, Hsin-Chu (TW)

(21) Appl. No.: 16/917,923

(22) Filed: Jul. 1, 2020

(30) Foreign Application Priority Data
Jul. 5, 2019 (CN) 201910602151.7

(51) Int. Cl. F21V 8/00

(52) U.S. Cl. CPC G02B 6/005; G02B 6/0036; G02B 6/0041

(57) ABSTRACT

The present disclosure provides a display device, which includes an invisible light source module, a wavelength conversion pattern and a display panel. The invisible light source module is configured to provide an invisible light beam. The wavelength conversion pattern is located on a transmission path of the invisible light beam. The wavelength conversion pattern is formed by a wavelength conversion material, the wavelength conversion material is configured to convert invisible light into visible light, and the invisible light beam forms a visible light pattern through the wavelength conversion pattern. The present disclosure also discloses a display control method for controlling a display device. The display device and the display control method of the present disclosure have multiple display modes and may display a preset pattern in a display mode driven by a low-power power supply.

### CROSS-REFERENCE TO RELATED APPLICATION

This application claims the priority benefit of China application serial no. 201910602151.7, filed on Jul. 5, 2019. The entirety of the above-mentioned patent application is hereby incorporated by reference herein and made a part of this specification.

### BACKGROUND OF THE DISCLOSURE

### Field of the Disclosure

The present disclosure relates to an optical device and a control method, and in particular, to a display device and a display control method.

### Description of Related Art

Generally speaking, a known flat-panel display, for example, a liquid crystal display (LCD), mainly includes components such as an LCD panel and a backlight module, the LCD panel does not emit light, and for enabling the flat-panel display to clearly display an image, the backlight module is required to provide illumination. A known backlight module includes components such as a light source, a light guide plate and an optical thin film, and the backlight module mostly adopts a light emitting diode (LED) capable of emitting a visible light band.

However, the LED capable of emitting a visible light band requires certain driving power. Therefore, under the condition that a known backlight module is adopted, if a display mode for a standby state is added to meet a business requirement, certain energy sources and power still require to be consumed, which may increase the operating cost of a product and affect the energy efficiency of the product and does not meet market requirements.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY OF THE DISCLOSURE

The present disclosure provides a display device, which has multiple display modes and may display a preset pattern in a display mode driven by a low-power power supply.

The present disclosure provides a display control method, which has multiple display modes and may display a preset pattern in a display mode driven by a low-power power supply.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

In order to achieve one or part or all of the foregoing objectives or other objectives, an embodiment of the present disclosure provides a display device. The display device includes an invisible light source module, a wavelength conversion pattern and a display panel. The invisible light source module includes a light guide plate, a first anti-invisible light penetrative layer and an invisible light source. The first anti-invisible light penetrative layer is located on the light guide plate. The invisible light source is configured to provide an invisible light beam and located beside the light guide plate. The wavelength conversion pattern is located on a transmission path of the invisible light beam. The wavelength conversion pattern is formed by a wavelength conversion material, and the wavelength conversion material is configured to convert invisible light into visible light. The invisible light beam is incident to the wavelength conversion pattern via the light guide plate, and the invisible light beam forms a visible light pattern through the wavelength conversion pattern. The light guide plate is located between the display panel and the first anti-invisible light penetrative layer.

In order to achieve one or part or all of the foregoing objectives or other objectives, an embodiment of the present disclosure discloses a display control method for controlling a display device. The display device includes an invisible light source module, a wavelength conversion pattern, a display panel and a visible light source module. The display panel is located between the invisible light source module and the visible light source module. The invisible light source module includes a light guide plate and an invisible light source. The invisible light source is configured to provide an invisible light beam and located beside the light guide plate. The wavelength conversion pattern is located on a transmission path of the invisible light beam and formed by a wavelength conversion material, and the wavelength conversion material is configured to convert invisible light into visible light. The display control method includes the following steps. The invisible light source module is turned on and the visible light source module is turned off, to form a visible light pattern, the invisible light beam provided by the invisible light source being incident to the wavelength conversion pattern via the light guide plate, and the invisible light beam forming the visible light pattern through the wavelength conversion pattern. The visible light source module is turned on and the invisible light source module is turned off, to form an image picture, the visible light source module being configured to provide a visible light beam, and the visible light beam forming the image picture after passing through the display panel.

Based on the foregoing, the embodiments of the present disclosure have at least one of the following advantages or effects. In the embodiments of the present disclosure, with configuration of the invisible light source module and the wavelength conversion pattern, the display device may display a preset pattern when being driven by a low-power power supply. Therefore, the display device and the display control method may have an image display mode in which a normal image picture may be displayed and a pattern display mode for a standby state, energy sources and power consumed by the pattern display mode for the standby state are obviously lower than those consumed by the image display mode in which the normal image picture may be displayed, the operating cost of a product may be reduced, the energy efficiency of the product may be improved, and marketing is facilitated.

In order to make the aforementioned characteristic and advantage of the present disclosure more comprehensible, embodiments are further described in detail hereinafter in reference to accompanying drawings.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is an architecture diagram of a display device according to an embodiment of the present disclosure.

FIG. 1B and FIG. 1C are schematic diagrams of a picture displayed by the display device in FIG. 1A in different display modes.

FIG. 2 to FIG. 6 are architecture diagrams of different display devices according to other embodiments of the present disclosure.

### DESCRIPTION OF THE EMBODIMENTS

Embodiments of the present disclosure will be illustrated below with the accompanying drawings. The directional terms mentioned in the present disclosure, like “above”, “below”, “front”, “back”, “left”, and “right”, refer to the directions in the appended drawings. Therefore, the directional terms are only used for illustration instead of limiting the present disclosure.

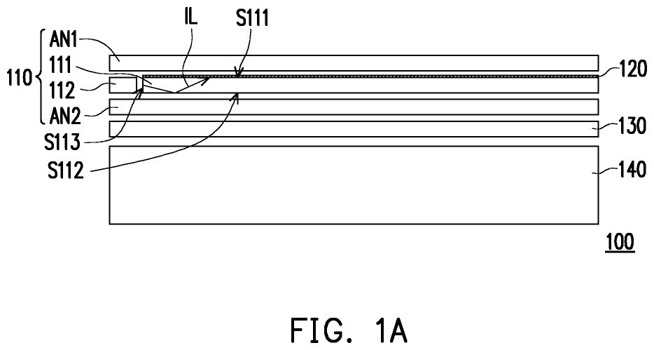

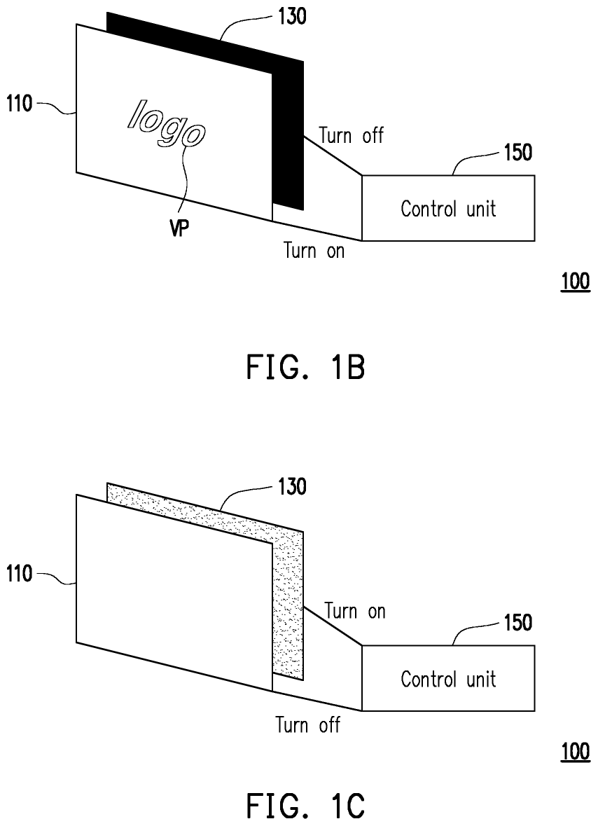

FIG. 1A is an architecture diagram of a display device according to an embodiment of the present disclosure. FIG. 1B and FIG. 1C are schematic diagrams of a picture displayed by the display device in FIG. 1A in different display modes. Referring to FIG. 1A, the display device 100 of the present embodiment includes an invisible light source module 110, a wavelength conversion pattern 120, a display panel 130 and a visible light source module 140. For example, in the present embodiment, the display panel 130 may be an LCD panel, and the visible light source module 140 may be a side incident type light source module and a direct type light source module, adopts an LED as a luminous element, and is configured to provide a visible light beam (not shown) to provide illumination for the display panel 130. However, the present disclosure is not limited thereto. In other embodiments, the display panel 130 may be an organic light-emitting diode (OLED) display panel, and the visible light source module 140 may be omitted.

Specifically, as shown in FIG. 1A and FIG. 1B, in the present embodiment, the display panel 130 is located between the invisible light source module 110 and the visible light source module 140. When the visible light source module 140 is in an on state, the visible light beam provided by the visible light source module 140 forms an image picture after passing through the display panel 130, and thus the display device 100 may be in an image display mode in which a normal image picture is displayed.

On the other hand, as shown in FIG. 1A, in the present embodiment, the invisible light source module 110 includes a light guide plate 111, a first anti-invisible light penetrative layer AN1 and an invisible light source 112. The invisible light source 112 may be an LED capable of emitting an infrared (IR) band or an ultraviolet (UV) band, and is configured to provide an invisible light beam IL. Specifically, as shown in FIG. 1A, in the present embodiment, the light guide plate 111 includes a first surface S111, a second surface S112 and an incident surface S113, the first surface S111 is opposite to the second surface S112, and the incident surface S113 connects the first surface S111 and the second surface S112. The invisible light source 112 is located beside the incident surface S113 of the light guide plate 111, and thus the invisible light beam IL enters the light guide plate 111 via the incident surface S113 and is transmitted in the light guide plate 111.

Further, as shown in FIG. 1A and FIG. 1C, in the present embodiment, the wavelength conversion pattern 120 is formed by a wavelength conversion material, the wavelength conversion material is configured to convert invisible light into visible light, and the wavelength conversion pattern 120 is located on a transmission path of the invisible light beam IL. Specifically, in the present embodiment, the wavelength conversion pattern 120 is located on one surface of the light guide plate 111, and the surface, where the wavelength conversion pattern 120 is located, of the light guide plate 111 is parallel to the display panel 130. For example, the wavelength conversion pattern 120 may be located on the first surface S111 of the light guide plate 111, and then when being transmitted in the light guide plate 111, the invisible light beam IL may be incident to the wavelength conversion pattern 120 via the light guide plate 111 and form a visible light pattern VP through the wavelength conversion pattern 120 to leave the light guide plate 111. Therefore, with configuration of the visible light pattern VP formed by the wavelength conversion pattern 120, the display device 100 may display a required preset pattern, and the display device 100 may be in a pattern display mode for a standby state.

More specifically, as shown in FIG. 1B and FIG. 1C, in the present embodiment, the display device 100 further includes a control unit 150, and the control unit 150 is electrically connected with the invisible light source module 110 and the visible light source module 140. As shown in FIG. 1B, in the present embodiment, the control unit 150 turns off the invisible light source module 110 when turning on the visible light source module 140, and then the display device 100 may be in the image display mode and display the normal image picture. As shown in FIG. 1C, in the present embodiment, the control unit 150 turns off the visible light source module 140 when turning on the invisible light source module 110, and then the display device 100 may be in the pattern display mode for the standby state and display the preset pattern. Further, in the present embodiment, driving power of the visible light source module 140 is determined by the size of the display panel 130, and is 1.3 to 140 watts (for the display panel 130 of about 6 inches to 65 inches), and for the display panel 130 in the same size, driving power of the invisible light source module 110 only requires to be 10 to 140 milliwatts. That is, in the present embodiment, a ratio of the driving power of the invisible light source module 110 to the driving power of the visible light source module 140 is less than 0.01.

Therefore, with configuration of the invisible light source module 110 and the wavelength conversion pattern 120, the display device 100 may display the preset pattern when being driven by a low-power power supply. Moreover, the display device 100 and a display control method may also have the image display mode in which the normal image picture may be displayed and the pattern display mode for the standby state, energy sources and power consumed by the pattern display mode for the standby state are obviously lower than those consumed by the image display mode in which the normal image picture may be displayed, the operating cost of a product may be reduced, the energy efficiency of the product may be improved, and marketing is facilitated.

In addition, as shown in FIG. 1A, in the present embodiment, the first anti-invisible light penetrative layer AN1 is located on a side of a first surface S111 of the light guide plate 111, and the display panel 130 is located on a side of a second surface S112 of the light guide plate 111. That is, in the present embodiment, the light guide plate 111 is located between the display panel 130 and the first anti-invisible light penetrative layer AN1, and the wavelength conversion pattern 120 is located between the light guide plate 111 and the first anti-invisible light penetrative layer AN1. Therefore, with arrangement of the first anti-invisible light penetrative layer AN1, the display device 100 may prevent influence of incidence of invisible light in ambient light to the wavelength conversion pattern 120 on the normal image picture displayed by the display device 100 in the image display mode, and may also prevent harm to human eyes by the invisible light that is not converted by the wavelength conversion pattern 120 and penetrates through the light guide plate 111.

Moreover, in the present embodiment, the display device 100 may further selectively include a second anti-invisible light penetrative layer AN2, and the second anti-invisible light penetrative layer AN2 is located between the wavelength conversion pattern 120 and the display panel 130. Therefore, with arrangement of the second anti-invisible light penetrative layer AN2, a small amount of invisible light from the display panel 130 may be blocked to prevent the display device 100 in the image display mode from simultaneously displaying the normal image picture and the faint preset pattern.

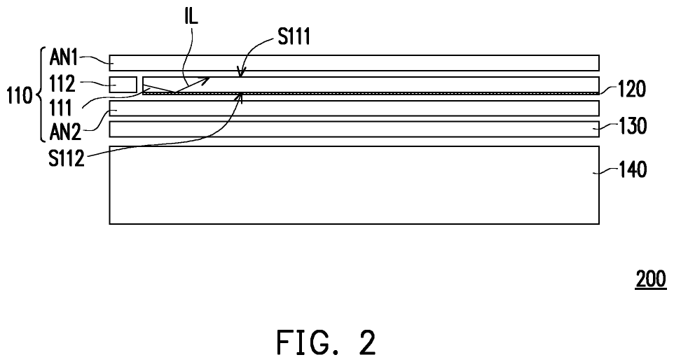

FIG. 2 is an architecture diagram of a display device according to another embodiment of the present disclosure. Referring to FIG. 2, the display device 200 of the present embodiment is similar to the display device 100 shown in FIG. 1A, and the difference is described below. In the present embodiment, a wavelength conversion pattern 120 of the display device 200 is located on a second surface S112 of a light guide plate 111, namely the wavelength conversion pattern 120 is located between the light guide plate 111 and a display panel 130. In such a manner, when being transmitted in the light guide plate 111, an invisible light beam IL may also be incident to the wavelength conversion pattern 120 via the light guide plate 111 and form a visible light pattern VP through the wavelength conversion pattern 120 to leave the light guide plate 111. Therefore, with configuration of the invisible light source module 110 and the wavelength conversion pattern 120, the display device 200 may also display a preset pattern when being driven by a low-power power supply. Moreover, since the display device 200 has a structure similar to that of the display device 100, the display device 200 may also realize functions similar to those of the display device 100 shown in FIG. 1A to achieve effects and advantages similar to those achieved by the display device 100. Elaborations are omitted herein.

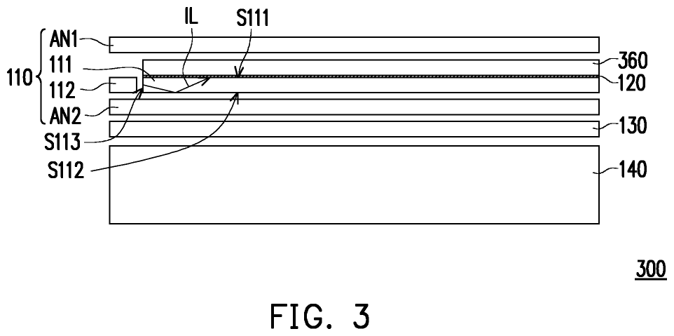

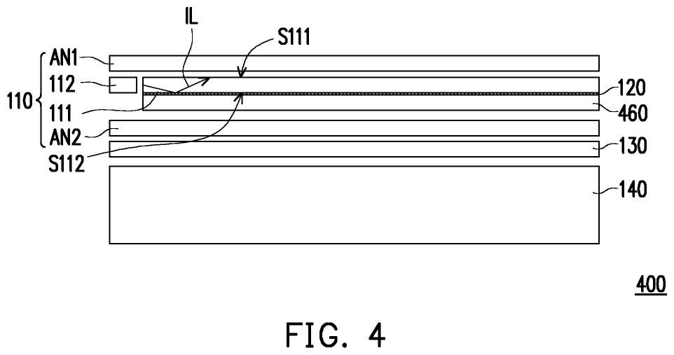

FIG. 3 to FIG. 4 are architecture diagrams of different display devices according to other embodiments of the present disclosure. Referring to FIG. 3 to FIG. 4, the display devices 300 and 400 of these embodiments are similar to the display devices 100 shown in FIG. 1A and FIG. 2, and the difference is described below. In the embodiments shown in FIG. 3 to FIG. 4, the display devices 300 and 400 further include wavelength conversion layers 360 and 460 respectively, and wavelength conversion patterns 120 are formed on the wavelength conversion layers 360 and 460. More specifically, in the embodiments shown in FIG. 3 to FIG. 4, the wavelength conversion layers 360 and 460 are adjacent to light guide plates 111, and the wavelength conversion patterns 120 are formed on surfaces, adjacent to the light guide plates 111, of the wavelength conversion layers 360 and 460. For example, as shown in FIG. 3, when the wavelength conversion layer 360 is located between the light guide plate 111 and a first anti-invisible light penetrative layer AN1, the wavelength conversion pattern 120 of the display device 300 is located on a surface, adjacent to a first surface S111 of the light guide plate 111, of the wavelength conversion layer 360 to be located on a side of first surface S111 of the light guide plate 111. On the other hand, as shown in FIG. 4, when the wavelength conversion layer 460 is located between the light guide plate 111 and a display panel 130, the wavelength conversion pattern 120 of the display device 400 is located on a surface, adjacent to a second surface S112 of the light guide plate 111, of the wavelength conversion layer 460 to be located on a side of a second surface S112 of the light guide plate 111.

In such a manner, in the embodiments shown in FIG. 3 to FIG. 4, when being transmitted in the light guide plate 111, an invisible light beam IL may also contact with the wavelength conversion patterns 120 on the wavelength conversion layers 360 and 460 via the light guide plates 111 to leave the light guide plates 111, be incident to the wavelength conversion layers 360 and 460 and form a visible light pattern VP through the wavelength conversion patterns 120. Therefore, with configuration of invisible light source modules 110 and the wavelength conversion patterns 120, the display devices 300 and 400 may also display a preset pattern when being driven by a low-power power supply. Moreover, since the display devices 300 and 400 have structures similar to that of the display device 100, the display devices 300 and 400 may also realize functions similar to those of the display device 100 shown in FIG. 1A to achieve effects and advantages similar to those achieved by the display device 100. Elaborations are omitted herein.

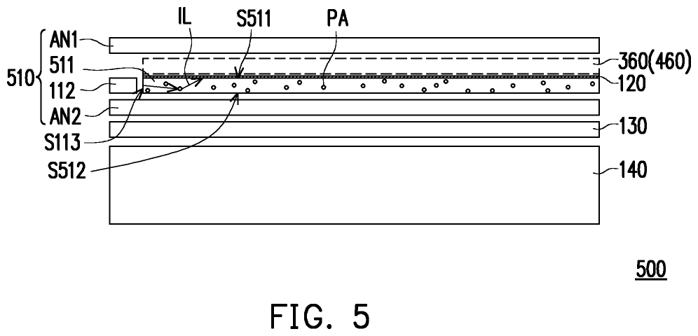

FIG. 5 is an architecture diagram of a display device according to another embodiment of the present disclosure. Referring to FIG. 5, the display device 500 of the present embodiment is similar to the display device 100 shown in FIG. 1A, and the difference is described below. In the present embodiment, a light guide plate 511 of an invisible light source module 510 includes multiple diffused particles PA, and an invisible light beam IL leaves the light guide plate 511 via these diffused particles PA to be incident to a wavelength conversion pattern 120. In such a manner, in the present embodiment, a formation position of the wavelength conversion pattern 120 may not be limited, the wavelength conversion pattern 120 may be selectively arranged on a first surface S511 or second surface S512 of the light guide plate 511, and a wavelength conversion layer 360, 460 may be omitted. Or, when the wavelength conversion patterns 120 are arranged on the wavelength conversion layers 360 and 460, the wavelength conversion pattern 120 on the wavelength conversion layers 360 and 460 may not require to be adjacent to the light guide plate 511 and thus may be freely arranged on surfaces of the wavelength conversion layers 360 and 460 or in the wavelength conversion layers 360 and 460. Moreover, the wavelength conversion layers 360 and 460 may also selectively contact with the light guide plate 511 or be kept at a distance away from the light guide plate 511.

In the present embodiment, since the invisible light beam IL may leave the light guide plate 511 via these diffused particles PA and be incident to the wavelength conversion pattern 120, with configuration of the invisible light source module 510 and the wavelength conversion pattern 120, the display device 500 may also display a preset pattern when being driven by a low-power power supply. Moreover, since the display device 500 has a structure similar to that of the display device 100, the display device 500 may also realize functions similar to those of the display device 100 shown in FIG. 1A to achieve effects and advantages similar to those achieved by the display device 100. Elaborations are omitted herein.

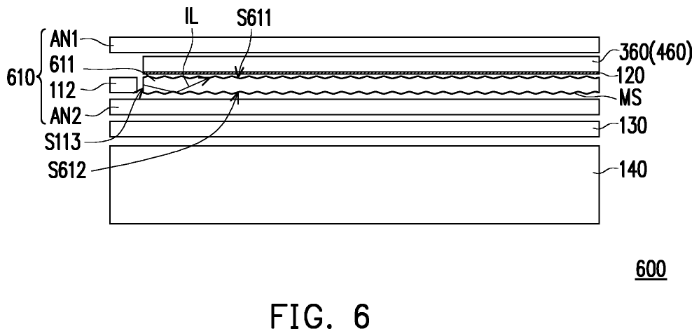

FIG. 6 is an architecture diagram of a display device according to another embodiment of the present disclosure. Referring to FIG. 6, the display device 600 of the present embodiment is similar to the display device 500 shown in FIG. 5, and the difference is described below. In the present embodiment, a light guide plate 611 of an invisible light source module 610 includes multiple microstructures MS, and these microstructures MS are at least located on one of a surface, facing a first anti-invisible light penetrative layer AN1, of the light guide plate 611 and a surface, facing a display panel 130, of the light guide plate 611, namely the microstructures MS may be selectively arranged on a first surface S611 or second surface S612 of the light guide plate 611, and an invisible light beam IL leaves the light guide plate 611 via these microstructures to be incident to a wavelength conversion layer 360.

In the present embodiment, since the invisible light beam IL may leave the light guide plate 611 via these microstructures MS to be incident to the wavelength conversion pattern 120, with configuration of the invisible light source module 610 and the wavelength conversion pattern 120, the display device 600 may also display a preset pattern when being driven by a low-power power supply. Moreover, since the display device 600 has a structure similar to that of the display device 500 shown in FIG. 5, the display device 600 may also realize functions similar to those of the display device 500 shown in FIG. 5 to achieve effects and advantages similar to those achieved by the display device 500. Elaborations are omitted herein.

Based on the foregoing, the embodiments of the present disclosure have at least one of the following advantages or effects. In the embodiments of the present disclosure, with configuration of the invisible light source module and the wavelength conversion pattern, the display device may display the preset pattern when being driven by the low-power power supply. Moreover, with arrangement of the first anti-invisible light penetrative layer, the display device may prevent influence of incidence of invisible light in ambient light to the wavelength conversion pattern on a normal image picture displayed by the display device in the image display mode, and may also prevent harm to human eyes by the invisible light that is not converted by the wavelength conversion pattern and penetrates through the light guide plate. Therefore, the display device and the display control method may have an image display mode in which a normal image picture may be displayed and a pattern display mode for a standby state, energy sources and power consumed by the pattern display mode for the standby state are obviously lower than those consumed by the image display mode in which the normal image picture may be displayed, the operating cost of a product may be reduced, the energy efficiency of the product may be improved, and marketing is facilitated.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. A display device, comprising an invisible light source module, a wavelength conversion pattern and a display panel, wherein
the invisible light source module comprises a light guide plate, a first anti-invisible light penetrative layer and an invisible light source,
the first anti-invisible light penetrative layer is located on the light guide plate, and
the invisible light source is configured to provide an invisible light beam and located beside the light guide plate;
the wavelength conversion pattern is located on a transmission path of the invisible light beam, the wavelength conversion pattern is formed by a wavelength conversion material, the wavelength conversion material is configured to convert invisible light into visible light, the invisible light beam is incident to the wavelength conversion pattern via the light guide plate, and the invisible light beam forms a visible light pattern through the wavelength conversion pattern; and
the light guide plate is located between the display panel and the first anti-invisible light penetrative layer.

2. The display device according to claim 1, wherein the wavelength conversion pattern is located between the light guide plate and the first anti-invisible light penetrative layer.

3. The display device according to claim 1, wherein the wavelength conversion pattern is located between the light guide plate and the display panel.

4. The display device according to claim 1, further comprising:
a second anti-invisible light penetrative layer, located between the wavelength conversion pattern and the display panel.

5. The display device according to claim 1, wherein the wavelength conversion pattern is located on one surface of the light guide plate, and the surface, where the wavelength conversion pattern is located, of the light guide plate is parallel to the display panel.

6. The display device according to claim 1, further comprising a wavelength conversion layer, wherein the wavelength conversion pattern is formed on the wavelength conversion layer.

7. The display device according to claim 6, wherein the wavelength conversion layer is adjacent to the light guide plate, the wavelength conversion pattern is formed on a surface, adjacent to the light guide plate, of the wavelength conversion layer, and the invisible light beam leaves the light guide plate via the wavelength conversion pattern to be incident to the wavelength conversion layer.

8. The display device according to claim 1, wherein the light guide plate comprises multiple diffused particles, and the invisible light beam leaves the light guide plate via the multiple diffused particles to be incident to the wavelength conversion pattern.

9. The display device according to claim 1, wherein the light guide plate comprises multiple microstructures, the multiple microstructures are at least located on one of a surface, facing the first anti-invisible light penetrative layer, of the light guide plate and a surface, facing the display panel, of the light guide plate, and the invisible light beam leaves the light guide plate via the multiple microstructures to be incident to the wavelength conversion pattern.

10. The display device according to claim 1, further comprising a visible light source module, wherein the display panel is located between the invisible light source module and the visible light source module, the visible light source module is configured to provide a visible light beam, and the visible light beam forms an image picture after passing through the display panel.

11. The display device according to claim 10, further comprising a control unit, electrically connected with the invisible light source module and the visible light source module, wherein the control unit turns off the visible light source module when turning on the invisible light source module, and the control unit turns off the invisible light source module when turning on the visible light source module.

12. The display device according to claim 10, wherein a ratio of driving power of the invisible light source module to driving power of the visible light source module is less than 0.01.

13. A display control method, used for controlling a display device, the display device comprising an invisible light source module, a wavelength conversion pattern, a display panel and a visible light source module, wherein the display panel is located between the invisible light source module and the visible light source module, the invisible light source module comprising a light guide plate and an invisible light source, the invisible light source is configured to provide an invisible light beam and located beside the light guide plate, the wavelength conversion pattern is located on a transmission path of the invisible light beam and formed by a wavelength conversion material, the wavelength conversion material is configured to convert invisible light into visible light, and the display control method comprising:
turning on the invisible light source module and turning off the visible light source module, to form a visible light pattern, wherein the invisible light beam provided by the invisible light source is incident to the wavelength conversion pattern via the light guide plate, and the invisible light beam forms the visible light pattern through the wavelength conversion pattern; and
turning on the visible light source module and turning off the invisible light source module, to form an image picture, wherein the visible light source module is configured to provide a visible light beam, and the visible light beam forms the image picture after passing through the display panel.

14. The display control method according to claim 13, wherein a ratio of driving power of the invisible light source module to driving power of the visible light source module is less than 0.01.

15. The display control method according to claim 13, wherein the wavelength conversion pattern is located on one surface of the light guide plate, and the surface, where the wavelength conversion pattern is located, of the light guide plate is parallel to the display panel.

16. The display control method according to claim 13, wherein the display device further comprises a wavelength conversion layer, and the wavelength conversion pattern is formed on the wavelength conversion layer.

17. The display control method according to claim 16, wherein the wavelength conversion layer contacts the light guide plate, the wavelength conversion pattern is formed on a surface, adjacent to the light guide plate, of the wavelength conversion layer, and the invisible light beam leaves the light guide plate via the wavelength conversion pattern to be incident to the wavelength conversion layer.

18. The display control method according to claim 13, wherein the light guide plate comprises multiple diffused particles, and the invisible light beam leaves the light guide plate via the multiple diffused particles to be incident to the wavelength conversion pattern.

19. The display control method according to claim 13, wherein the light guide plate comprises multiple microstructures, the multiple microstructures are at least located on one of a surface, facing a first anti-invisible light penetrative layer, of the light guide plate and a surface, facing the display panel, of the light guide plate, and the invisible light beam leaves the light guide plate via the multiple microstructures to be incident to the wavelength conversion pattern.
